(19) United States
(12) Patent Application Publication
(10) Pub. No.: US 2015/0308179 A1
(43) Pub. Date: Oct. 29, 2015

(54) MOTORIZED GATE SYSTEM AND METHOD FOR CONTROLLING SAME

(71) Applicant: ATELIERS BOLDUC & FRERES INC., Sainte-Clotilde-de-Beauce (CA)

(72) Inventors: Yvan MERCIER, Sainte-Clotilde-de-Beauce (CA); Jerome LACHANCE, St-Martin (CA)

(21) Appl. No.: 14/265,200

(22) Filed: Apr. 29, 2014

(51) Int. Cl. E05F 15/70; E05B 65/00; E06B 11/02; E05F 17/00; E05F 15/611; E05F 15/79

(52) U.S. Cl. CPC E05F 15/70; E05F 15/611; E05F 15/79; E06B 11/022; E05F 17/004; E05B 65/0007; E05B 65/0003; E05F 2017/008

(57) ABSTRACT

A gate system. The gate system comprises a fixed support and a barrier arm assembly pivotally mounted to the fixed support and being pivotable between an obstructing configuration, a forward non-obstructing configuration, and a reverse non-obstructing configuration. The motorized gate system also comprises at least one event detector configured to detect an occurrence of at least one forward opening event and at least one reverse opening event and a drive assembly operatively connected to the barrier arm assembly to rotate same clockwise and counterclockwise between the obstructing configuration, the forward non-obstructing configuration, and the reverse non-obstructing configuration. A method for controlling same is also provided.

### FIELD OF THE INVENTION

The present invention relates to the field of gate systems. More particularly, it relates to a motorized gate system with automatic locking and unlocking features and to a method for controlling the same.

### BACKGROUND

Several types of gate systems are known in the art to restrict and/or control the passage of users from a first area to a second area. Such systems usually include a barrier arm which is operative to grant or deny passage in a specific direction.

However known gate systems usually require user to manually displace the barriers arms of the gate systems between an obstructing configuration and at least one of a forward non-obstructing configuration and a reverse non-obstructing configuration, usually located at 90° angles in a forward angular direction or a reverse angular direction. In other words, the gate system may operate to unlock the barrier arm to allow pivoting of the barrier arm in the specific direction, but pivoting of the barrier requires a user to manually push the barrier open either to open the barrier in the forward angular direction or in the reverse angular direction.

In view of the above, there is a need for an improved gate system and method for operating the same which would be able to overcome or at least minimize some of the above-discussed prior art concerns.

### SUMMARY OF THE INVENTION

According to a first general aspect, there is provided a motorized gate system. The motorized gate system comprises a fixed support and a barrier arm assembly pivotally mounted to the fixed support and being pivotable between an obstructing configuration, a forward non-obstructing configuration, and a reverse non-obstructing configuration. The motorized gate system also comprises at least one event detector configured to detect an occurrence of at least one forward opening event and at least one reverse opening event and a drive assembly operatively connected to the barrier arm assembly to rotate same clockwise and counterclockwise between the obstructing configuration, the forward non-obstructing configuration, and the reverse non-obstructing configuration.

In an embodiment, the gate system further comprises a locking mechanism configurable in a locked configuration locking the barrier arm assembly in the obstructing configuration, a forward unlocked configuration allowing pivoting of the barrier arm assembly between the obstructing configuration and the forward non-obstructing configuration, and at least one of a reverse unlocked configuration and an unlocked configuration allowing pivoting of the barrier arm assembly between the obstructing configuration and the reverse non-obstructing configuration.

In an embodiment, the gate system further comprises a controller operatively connected to the at least one event detector, the locking mechanism, and the drive assembly, the controller being configured to configure the locking mechanism in the forward unlocked configuration and activate the drive assembly to drive the barrier arm assembly between the obstructing configuration and the forward non-obstructing configuration, upon detection of the occurrence of the forward opening event by the at least one event detector.

In an embodiment, the at least one event detector comprises at least two event detectors and the controller is configured to configure the locking mechanism in the forward unlocked configuration upon detection of the occurrence of a first forward opening event by a first one of the at least two event detectors, and to activate the drive assembly to drive the barrier arm assembly between the obstructing configuration and the forward non-obstructing configuration, upon detection of a second forward opening event by a second one of the at least two event detectors.

In an embodiment, the controller is configured to configure the locking mechanism in one of the reverse unlocked configuration and the unlocked configuration and to activate the drive assembly to drive the barrier arm assembly between the obstructing configuration and the reverse non-obstructing configuration, upon detection of the occurrence of the reverse opening event by the at least one event detector.

In an embodiment, the at least one event detector comprises at least two event detectors and the controller is configured to configure the locking mechanism in one of the reverse unlocked configuration and the unlocked configuration upon detection of the occurrence of a first reverse opening event by a first one of the at least two event detectors, and to activate the drive assembly to drive the barrier arm assembly between the obstructing configuration and the reverse non-obstructing configuration, upon detection of the occurrence of a second reverse opening event by a second one of the at least two event detectors.

In an embodiment, the barrier arm assembly comprises a locking stopper with a forward abutment surface and a reverse abutment surface and the locking mechanism comprises a forward rotation solenoid with a forward arresting latch selectively engageable with the forward abutment surface in the locked and reversed unlocked configurations and a reverse rotation solenoid with a reverse arresting latch selectively engageable with the reverse abutment surface in the locked and forward unlocked configurations.

In an embodiment, the fixed support comprises a fixed abutment member and the barrier arm assembly comprises a course stopper having a forward abutment surface and a reverse abutment surface respectively positioned to contact a side of the fixed abutment member when the barrier arm assembly reaches a respective one of the forward non-obstructing configuration and the reverse non-obstructing configuration.

In an embodiment, the course stopper comprises a dampening cavity, a coupler and a resilient spider, the coupler and the resilient spider being inserted in the dampening cavity with the resilient spider being compressible to dampen a movement of the barrier arm assembly when one of the forward non-obstructing configuration or the reverse non-obstructing configuration is reached.

In an embodiment, the barrier arm assembly comprises a rotatable member and the drive assembly comprises a drive shaft and a coupling, the drive shaft being substantially aligned with the rotatable member and engaged therewith through the coupling.

In an embodiment, the drive assembly comprises a stepper motor.

In an embodiment, the gate system further comprises an angular position sensor configured to detect an angular position of the barrier arm assembly, the angular position sensor comprising a magnetic position sensor, a permanent magnet and an electronic card, the magnetic position sensor being connected to the electronic card and sensing an orientation of the permanent magnet, the permanent magnet rotating synchronously with at least one of the drive shaft of the drive assembly and the barrier arm assembly, the orientation of the permanent magnet being modified when rotated.

According to another general aspect, there is also provided a method for controlling a motorized gate system having a barrier arm assembly pivotable between an obstructing configuration, a forward non-obstructing configuration and a reverse non-obstructing configuration, a drive assembly operatively connected to the barrier arm assembly and a locking mechanism operatively connected to the barrier arm assembly. The method comprises the steps of: monitoring an occurrence of a forward opening event and a reverse opening event by at least one event detector; upon detection of the occurrence of the forward opening event: driving the drive assembly in a forward angular direction to pivot the barrier arm assembly towards the forward non-obstructing configuration; and driving the drive assembly in a reverse angular direction to return the barrier arm assembly to the obstructing configuration; and upon detection of an occurrence of the reverse opening event, driving the drive assembly in the reverse angular direction to pivot the barrier arm assembly towards the reverse non-obstructing configuration.

In an embodiment, the method further comprises the step of configuring the locking mechanism in a forward unlocked configuration upon detection of the occurrence of the forward opening event.

In an embodiment, the detection of the occurrence of the forward opening event comprises the detection of a first forward opening event and a second forward opening event, the detection of the first forward opening event triggering the step of configuring the locking mechanism in the forward unlocked configuration and the detection of the second forward opening event triggering the step of driving the drive assembly.

In an embodiment, the method further comprises the step of maintaining the barrier arm assembly in the forward non-obstructing configuration for a time period.

In an embodiment, the method further comprises the step of configuring the locking mechanism in the locked configuration to lock the barrier arm assembly in the obstructing configuration, once the barrier arm assembly has returned to the obstructing configuration from the forward non-obstructing configuration.

In an embodiment, the method further comprises the step of configuring the locking mechanism in one of a reverse unlocked configuration and an unlocked configuration to allow pivoting of the barrier arm assembly at least towards the reverse non-obstructing configuration, upon detection of an occurrence of the reverse opening event.

In an embodiment, upon detection of an occurrence of the reverse opening event, the method further comprises: maintaining the barrier arm assembly in the reverse non-obstructing configuration for a time period; driving the drive assembly operatively connected to the barrier arm assembly in the forward angular direction to return the barrier arm assembly to the obstructing configuration; and configuring the locking mechanism in the locked configuration to lock the barrier arm assembly in the obstructing configuration.

In an embodiment, the method further comprises the step of detecting an angular position of the barrier arm assembly and the steps of configuring the locking mechanism in the locked configuration is performed if the detected angular position is the angular position corresponding to the obstructing configuration.

In an embodiment, the barrier arm assembly comprises a rotatable member and the drive assembly comprises a drive shaft aligned and directly connected to the rotatable member and the step of driving the drive assembly operatively connected to the barrier arm assembly comprises the step of rotating the drive shaft of the drive assembly to engage the rotatable member in rotation.

According to another general aspect, there is further provided a gate system. The gate system comprises a fixed support and a barrier arm assembly pivotally mounted to the fixed support and being pivotable between an obstructing configuration, a forward non-obstructing configuration, and a reverse non-obstructing configuration, the barrier arm assembly having a locking stopper with a forward abutment surface and a reverse abutment surface. The gate system also comprises a forward rotation solenoid with a forward arresting latch selectively engageable with the forward abutment surface of the locking stopper in a locked configuration and a reversed unlocked configuration. The gate system also comprises a reverse rotation solenoid with a reverse arresting latch selectively engageable with the reverse abutment surface in the locked configuration and a forward unlocked configuration.

In an embodiment, the gate system further comprises at least one event detector configured to detect an occurrence of at least a forward opening event and a reverse opening event.

In an embodiment, the gate system further comprises a drive assembly operatively connected to the barrier arm assembly to rotate same clockwise and counterclockwise between the obstructing configuration, the forward non-obstructing configuration, and the reverse non-obstructing configuration.

In an embodiment, the fixed support comprises a fixed abutment member and the barrier arm assembly comprises a course stopper having a forward abutment surface and a reverse abutment surface respectively positioned to contact a side of the fixed abutment member when the barrier arm assembly reaches a respective one of the forward non-obstructing configuration and the reverse non-obstructing configuration.

In an embodiment, the course stopper comprises a dampening cavity, a coupler and a resilient spider, the coupler and the resilient spider being inserted in the dampening cavity with the resilient spider being compressible to dampen a movement of the barrier arm assembly when one of the forward non-obstructing configuration or the reverse non-obstructing configuration is reached.

In an embodiment, the barrier arm assembly comprises a rotatable member and the drive assembly comprises a drive shaft and a coupling, the drive shaft being substantially aligned with the rotatable member and engaged therewith through the coupling.

In an embodiment, the drive assembly comprises a stepper motor.

In an embodiment, the gate system further comprises an angular position sensor configured to detect an angular position of the barrier arm assembly, the angular position sensor comprising a magnetic position sensor, a permanent magnet and an electronic card, the magnetic position sensor being connected to the electronic card and sensing an orientation of the permanent magnet, the permanent magnet rotating synchronously with at least one of the drive shaft of the drive assembly and the barrier arm assembly, the orientation of the permanent magnet being modified when rotated.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIGS. 1 and 1a are respectively a front elevation view and a top plan view of a gate system according to an embodiment where the gate system is a single gate system.

FIG. 2 is a perspective view of a barrier arm mounted to a fixed support of the gate system according to an embodiment, wherein the covers are removed.

FIGS. 3 to 3c are perspective views, enlarged and fragmented, of the locking mechanism of the gate system of FIG. 2, wherein the locking mechanism is shown in a locked configuration in FIG. 3, a forward unlocked configuration in FIG. 3a, a reverse unlocked configuration in FIG. 3b and an unlocked configuration in FIG. 3c.

FIG. 4 is a perspective view, enlarged and fragmented, of a drive assembly connected to the barrier arm of the gate system of FIG. 2.

FIG. 5 is a close-up perspective view of a top section of the barrier arm of the gate system of FIG. 2.

FIG. 6 is an exploded view of the top section of the barrier arm of the gate system of FIG. 2 shown in FIG. 5.

FIGS. 7 and 7a are respectively a front elevation view and a top plan view of a gate system according to an embodiment where the gate system is a double-gate system.

### DETAILED DESCRIPTION

In the following description, the same numerical references refer to similar elements. The embodiments, geometrical configurations, materials mentioned and/or dimensions shown in the figures or described in the present description are embodiments only, given solely for exemplification purposes.

Moreover, although the embodiments of the motorized gate system and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the motorized gate system, as will be briefly explained herein and as can be easily inferred herefrom by a person skilled in the art. Moreover, it will be appreciated that positional descriptions such as “above”, “below”, “left”, “right”, “forward”, “reverse” and the like should, unless otherwise indicated, be taken in the context of the figures and should not be considered limiting.

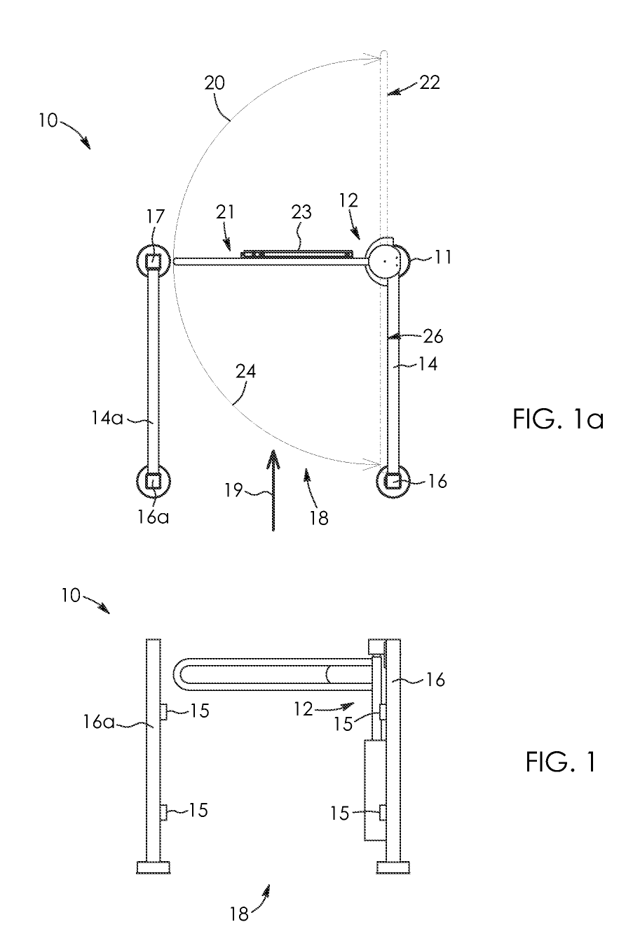

Referring generally to FIGS. 1 and 1a, there is provided a motorized gate system 10. For example and without being limitative, the gate system 10 may be used, as an entrance gate system for controlling passage of users in a store or the like. One skilled in the art will understand that, in an alternative embodiment, the gate system 10 could be used for any application where control of the passage of users in a passageway is desirable.

The gate system 10 includes a fixed support 11 with a barrier arm assembly 12 pivotally mounted thereto. In the embodiment shown, the gate system 10 further includes a first barrier section 14 connected at a first end to the fixed support 11 and at a second end to a first entry post 16 and a second barrier section 14a extending substantially parallel and spaced apart from the first barrier section 14. The second barrier section 14a extends between a second entry post 16a and an exit post 17 substantially aligned with the fixed support 11. The first and second barrier sections 14, 14a define a restricted passageway 18. Each one of the fixed support 11, the first entry post 16, the second entry post 16a and the exit post 17 are rigidly anchored to the ground in order to form the restricted passageway 18. One skilled in the art will understand that, in an alternative embodiment, other means than the one of the embodiment shown could be provided to form the restricted passageway 18. For example and without being limitative, the fixed support 11 can be located at an exit of a passageway 18 formed by two opposed walls. The passageway 18 can also be defined between a wall and a barrier section defined between a post and the fixed support.

The barrier arm assembly 12 is normally configured in an obstructing configuration 21, shown in FIG. 1a, wherein the barrier arm assembly 12 is positioned substantially transversally across the passageway 18. The barrier arm assembly 12 is pivotable in a forward pivoting direction 20 about the fixed support 11 (i.e. a pivoting direction for opening the barrier arm to a user entering the store in the forward direction shown by arrow 19) between the obstructing configuration 21 and a forward non-obstructing configuration 22. In some implementations, the barrier arm assembly 12 is also pivotable in a reverse pivoting direction 24 about the fixed support 11 (i.e. a pivoting direction for opening the barrier arm to a user exiting the store in a reverse direction, i.e. a direction opposite of arrow 19) between the obstructing configuration 21 and a reverse non-obstructing configuration 26. In a non-limitative embodiment, in the forward non-obstructing configuration 22 and the reverse non-obstructing configuration 26, the barrier arm assembly 12 extends substantially parallel to the wall(s) or the barrier section(s) defining the passageway 18.

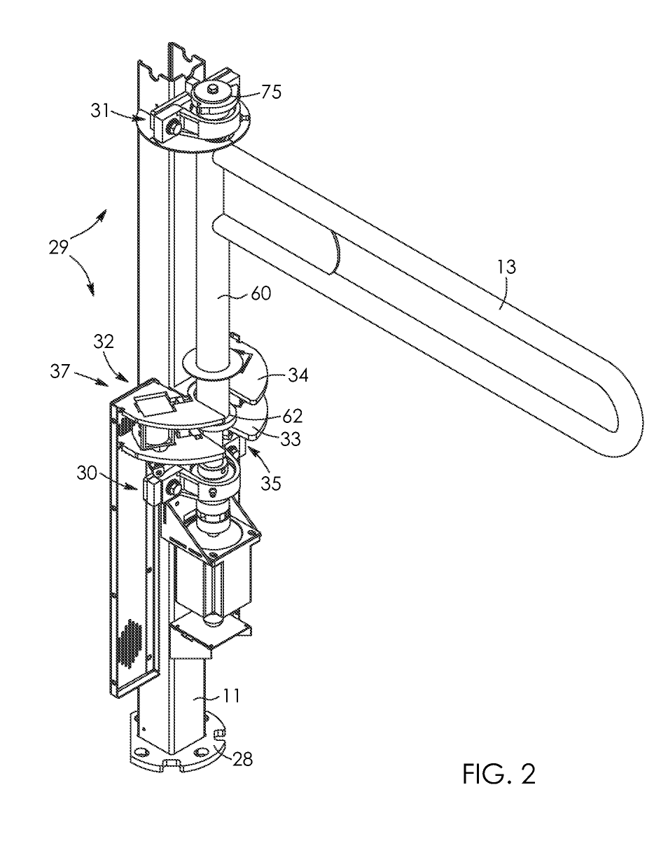

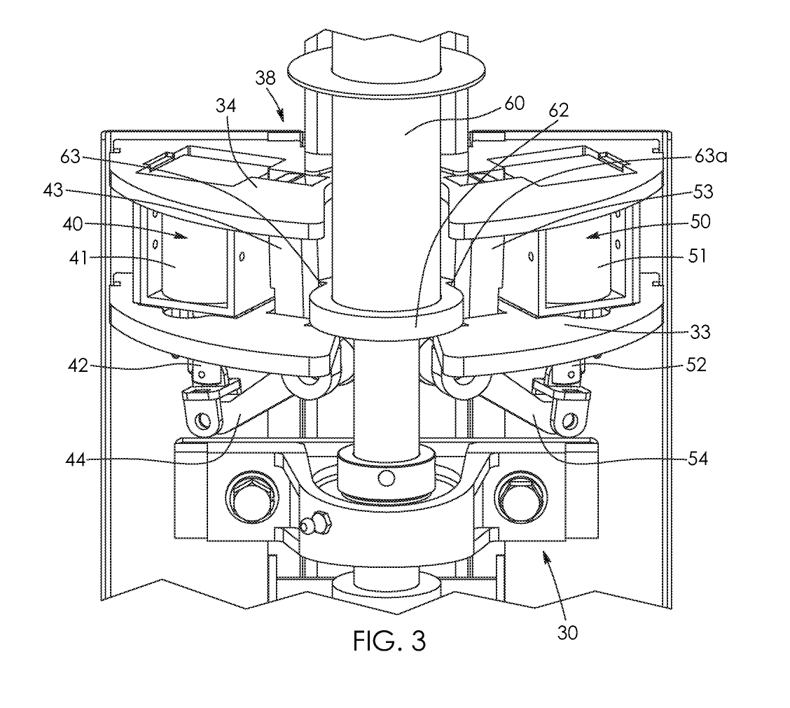

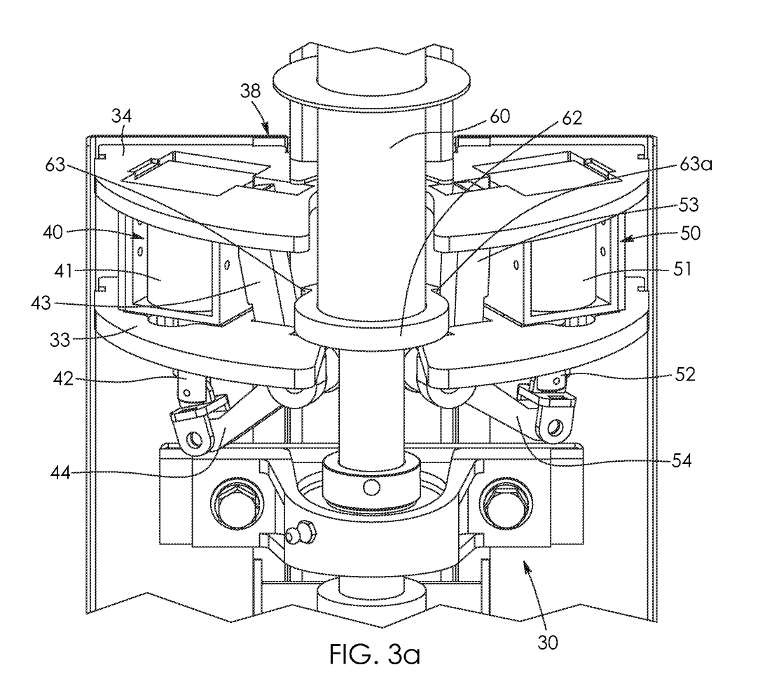

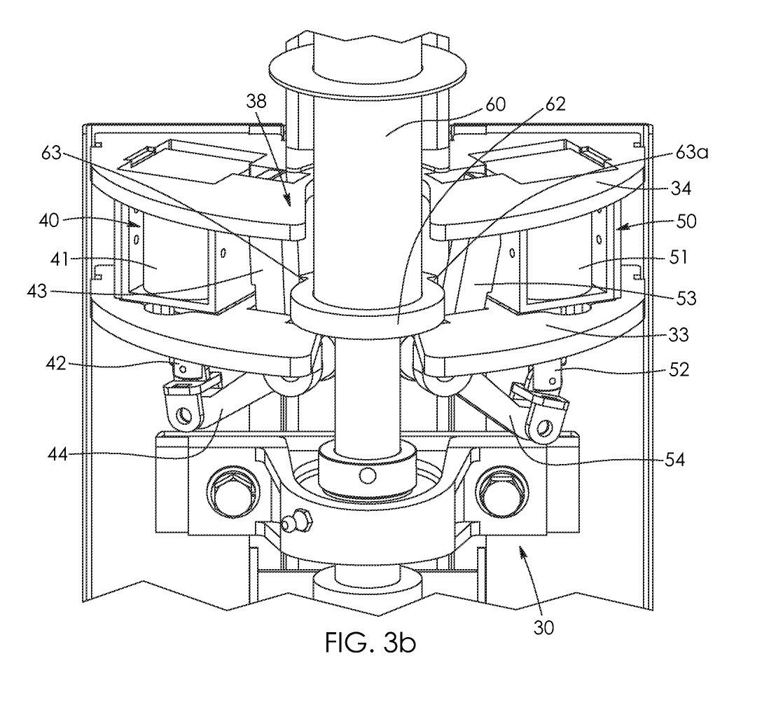

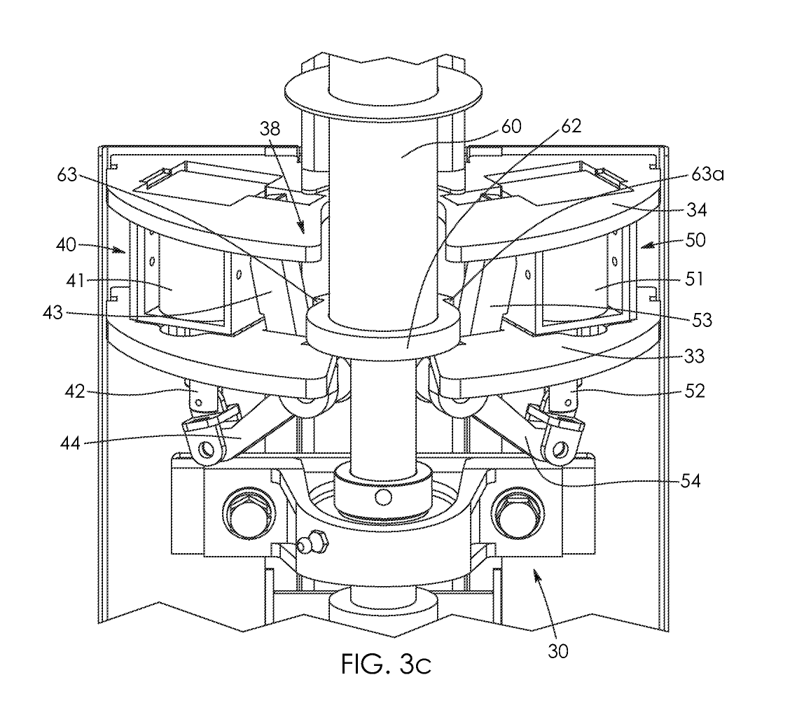

Now referring to FIGS. 2 and 3, the construction and operation of the barrier arm assembly 12 of the gate system 10, will be described in more details. As mentioned above, the fixed support 11 comprises a barrier arm assembly 12 to pivotally mount to the barrier arm assembly 12 thereto. The barrier arm assembly 12 comprises a rotatable tubular support member 60 for engagement with the fixed support 11 through the barrier support assembly 29 and a barrier 13 secured to the tubular support member 60. The barrier 13 extends substantially perpendicular to the tubular support member 60 and through the passageway 18 in the obstructing configuration 21. One skilled in the art will understand that the term “tubular support member 60” is used herein to describe the support member of the embodiment shown, but that, in alternative embodiments, a support member of a shape different from a tubular shape may be used.

In the embodiment shown, the fixed support 11 is a vertical support post, such as, without being limitative a metal post, with a securement base 28 allowing anchoring of the fixed support 11 to the ground. However, in an alternative embodiment (not shown), the fixed support 11 can be secured to a wall or wall section.

In the embodiment shown, the barrier support assembly 29 comprises a lower bracket 30 and an upper bracket 31, secured to the fixed support 11 and vertically spaced apart from one another. The lower and upper brackets 30, 31 are configured to pivotally receive a portion of the tubular support member 60 of the barrier arm assembly 12. When mounted to the fixed support 11 through the lower and upper brackets 30, 31, the tubular support member 60 extends substantially parallel thereto. The tubular support member 60 extends through apertures defined in the lower and upper brackets 30, 31. The lower and upper brackets 30, 31 engage the tubular support member 60 to the fixed support 11 and support the latter. In an embodiment, the barrier support assembly 29 further comprises at least two bearing assemblies (not shown). A respective one of the bearing assemblies extends between each one of the lower bracket 30 and the upper bracket 31 and the tubular support member 60. The bearing assemblies (not shown) allow rotation of the tubular support member 60 about a pivoting axis, which is aligned with the tubular support member 60. Rotation of the tubular support member 60 about its pivoting axis allows its configuration in the obstructing configuration 21, the forward non-obstructing configuration 22, and the reverse non-obstructing configuration 26.

In an embodiment, the gate system 10 also comprises a locking assembly 37 including a locking bracket 32 mounted to the fixed support 11. The locking bracket 32 includes two substantially horizontal support walls, spaced-apart from one another, namely a lower support wall 33 and an upper support wall 34, each one being mounted to the fixed support. Each one of the lower support wall 33 and the upper support wall 34 includes a U-shaped recess 35 through which the tubular support member 60 of the barrier arm assembly 12 extends and can rotate. A locking stopper 62 is mounted to the tubular support member 60. In the embodiment shown, the locking stopper 62 is a ring surrounding the tubular support member 60. The locking stopper 62 has two angularly spaced-apart abutment surfaces, namely a forward abutment surface 63 and a reverse abutment surface 63a, the purpose of which will be described in more details below.

Referring to FIGS. 3 to 3c, the locking assembly 37 comprises a locking mechanism 38 including a forward rotation solenoid 40 and a reverse rotation solenoid 50, mounted between the lower support wall 33 and the upper support wall 34 of the locking bracket 32. Each one of the forward rotation solenoid 40 and a reverse rotation solenoid 50 are mounted on a respective side of the tubular support member 60, with respect to the forward non-obstructing configuration 22 and the reverse non-obstructing configuration 26. One skilled in the art would understand that, in an embodiment, the gate system 10 could be free of locking assembly 37 and corresponding locking system 38.

The forward rotation solenoid 40 includes an energizable coil 41 which actuates a solenoid rod 42 connected to a pivotable forward arresting latch 43 through a pivotal linkage 44. The actuation of the solenoid rod 42 by the energizable coil 41 allows the positioning of the forward arresting latch 43 in an engaged configuration with respect to the forward abutment surface 63 of the locking stopper 62, as shown in FIGS. 3 and 3b and a disengaged configuration with respect to the forward abutment surface 63 of the locking stopper 62 as shown in FIGS. 3a and 3c. As will be better described below, the forward arresting latch 43 of the forward rotation solenoid 40 therefore constitutes a displaceable arresting member to either prevent forward pivoting of the barrier arm assembly 12 and lock the barrier arm assembly 12 in the obstructing configuration 21 or allow the pivoting of the barrier arm 12 between the obstructing configuration 21 and the forward non-obstructing configuration 22 relative to the passageway 18.

The reverse rotation solenoid 50 also includes an energizable coil 51 which actuates a solenoid rod 52 connected to a pivotable reverse arresting latch 53 through a pivotal linkage 54. The actuation of the solenoid rod 52 by the energizable coil 41 allows the positioning of the reverse arresting latch 53 in an engaged configuration with respect to the reverse abutment surface 63a of the locking stopper 62, as shown in FIGS. 3 and 3a and a disengaged configuration with respect to the reverse abutment surface 63a of the locking stopper 62 as shown in FIGS. 3b and 3c. As will be better described below, the reverse arresting latch 53 of the reverse rotation solenoid 50 therefore constitutes a displaceable arresting member to either prevent reverse pivoting of the barrier arm assembly 12 and lock the barrier arm assembly 12 in the obstructing configuration 21 or allow the pivoting of the barrier arm between the obstructing configuration 21 and the reverse non-obstructing configuration 26 relative to the passageway 18.

One skilled in the art will understand that, in an embodiment (not shown) locking mechanisms 38, different from the combined forward rotation solenoid 40 and the reverse rotation solenoid 50, can be provided. For example and without being limitative, only one of the forward rotation solenoid 40 and the reverse rotation solenoid 50 can be provided with a different locking member for the other one of the forward or reverse locking.

The locking mechanism 38 is configurable in a locked configuration, shown in FIG. 3, wherein the forward arresting latch 43 of the forward rotation solenoid 40 and the reverse arresting latch 53 of the reverse rotation solenoid 50 are in an engaged configuration with respect to the forward abutment surface 63 and the reverse abutment surface 63a of the locking stopper 62, thereby locking the barrier arm assembly 12 in the obstructing configuration. The locking mechanism 38 is also configurable in a forward unlocked configuration, shown in FIG. 3a, wherein the forward arresting latch 43 of the forward rotation solenoid 40 is in the disengaged configuration with respect to the forward abutment surface 63 of the locking stopper 62 and the reverse arresting latch 53 of the reverse rotation solenoid 50 is in the engaged configuration with respect to the reverse abutment surface 63a of the locking stopper 62, thereby allowing pivoting of the barrier arm assembly 12 between the obstructing configuration and the forward non-obstructing configuration and preventing pivoting of the barrier arm assembly 12 between the obstructing configuration and the reverse non-obstructing configuration. The locking mechanism 38 is further configurable in a reverse unlocked configuration, shown in FIG. 3b, wherein the forward arresting latch 43 of the forward rotation solenoid 40 is in the engaged configuration with respect to the forward abutment surface 63 of the locking stopper 62 and the reverse arresting latch 53 of the reverse rotation solenoid 50 is in the disengaged configuration with respect to the reverse abutment surface 63a of the locking stopper 62, thereby allowing pivoting of the barrier arm assembly 12 between the obstructing configuration and the reverse non-obstructing configuration and preventing pivoting of the barrier arm assembly 12 between the obstructing configuration and the forward non-obstructing configuration. The locking mechanism 38 is finally configurable in an unlocked configuration wherein the forward arresting latch 43 of the forward rotation solenoid 40 and the reverse arresting latch 53 of the reverse rotation solenoid 50 are in a disengaged configuration with respect to the forward abutment surface 63 and the reverse abutment surface 63a of the locking stopper 62, thereby allowing the barrier arm to pivot freely in between both of the forward and rearward non-obstructing configurations.

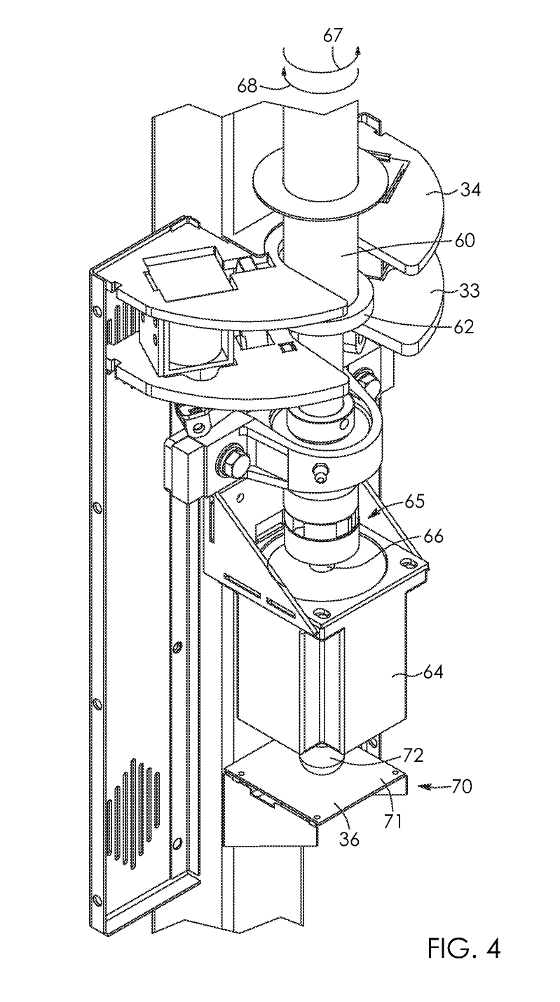

Now referring to FIG. 4, in the embodiment shown, the tubular support member 60 is operatively connected to a drive assembly 64 for engaging the latter in rotation about its rotation axis. Rotation of the tubular support member 60 engages the barrier 13 in rotation and therefore configures the barrier arm assembly 12 between the obstructing configuration and the forward and rearward non-obstructing configurations.

More particularly, the tubular support member 60, at a lower end thereof, is operatively connected to a drive shaft 66 of the drive assembly 64 through a coupling 65. In the embodiment shown, the drive shaft is aligned with the tubular support member 60 to directly drive same in rotation. One skilled in the art will understand that, in alternative embodiments, other coupling means or methods can be used for connecting the tubular support member 60 to the drive shaft 66 of the drive assembly 64.

In operation, the drive assembly 64 is operative to rotate the drive shaft 66 in one of the forward angular direction 67 or the reverse angular direction 68 (in a clockwise or counterclockwise direction). Therefore, operation of the drive assembly 64 results in angular movement of the tubular support member 60 of the barrier arm assembly 12 and a corresponding pivoting of the barrier arm assembly 12 between the obstructing configuration, the forward non-obstructing configuration and the reverse non-obstructing configuration. Pivoting of the tubular support member 60 of the barrier arm assembly 12 by the drive assembly 64 is synchronized with the operation of the above-described locking mechanism 38, such that the locking mechanism in configured in the suitable configuration to allow a corresponding pivoting of the tubular support member 60 of the barrier arm assembly 12 by the drive assembly 64 in the forward 67 or reverse 68 angular direction.

In an embodiment, the drive assembly 64 is a stepper motor allowing precise control of the angular movement of the drive shaft 66 and the tubular support member 60 connected thereto. One skilled in the art would however understand that, in alternative embodiments, other types of motors may be used for the drive assembly 64.

In an embodiment, the gate system 10 further includes an angular position sensor 70 operative to detect the angular position of the barrier arm assembly 12 and, more particularly, the barrier 13. In the embodiment shown, the angular position sensor 70 comprises a magnetic position sensor 71, operatively connected to an electronic card, and a permanent magnet 72 positioned at a lower end of the drive assembly 64 and rotating synchronously with the drive shaft 66 thereof and the tubular support member 60. The magnetic position sensor 71 detects the absolute angular position of a permanent magnet 72 and, thereby, the angular position of the barrier 13 of the barrier arm assembly 12. One skilled in the art would however understand that, in an alternative embodiment, an angular position sensor of any type which allows the detection of the angular position of the barrier arm assembly 12 can be used. In an alternative and non-limitative embodiment, the permanent magnet 72 can be provided on the tubular support member 60.

The angular position detected by the angular position sensor 70 may be used by the gate system 10 in order to deactivate or modify the rotation direction of the drive assembly 64 when the barrier arm has reached one of the obstructing configuration 21, the forward non-obstructing configuration 22 and the reverse non-obstructing configuration 26.

In an embodiment, the drive assembly 64 can be overridden during the pivoting of the barrier arm assembly 12, for example by a user pushing the barrier 13 of the barrier arm assembly 12 to enter the store more rapidly than the rotation movement provided by the drive assembly 64. In such an embodiment, following an override period, the angular position of the barrier arm assembly 12 is determined by the angular position sensor 70 and the drive assembly 64 operates to complete the angular movement required to move the barrier arm assembly 12 in the desired configuration.

Referring back to FIGS. 1 and 1a, there is shown that forward event detectors are provided to detect the occurrence of a forward opening event such as, motion between the first entry post 16 and the second entry post 16a. In an embodiment, the forward event detectors are optical sensors 15 mounted to the first entry post 16 and the second entry post 16a, in order to detect a motion of a person or an object entering into the passageway 18.

As will be described in more details below, in an embodiment upon detection of a person or an object entering into the passageway 18, the gate system 10 operates to temporarily unlock the forward arresting latch 43 to allow opening of the barrier arm assembly 12 and allow opening of the barrier arm assembly 12 forwardly to allow a user to enter the store. One skilled in the art will understand that the forward event detectors may be positioned differently than the optical sensors 15 of the embodiment shown, and may be of a different type. For example, the sensors may be pressure sensors for sensing a pressure on the barrier 13 of the barrier arm assembly 12 by a user, a barrier being pushed open by a user entering the passageway 18, or any other appropriate types of sensors.

In an embodiment, the forward event detector comprises at least two event detectors, to detect a combination of events to configure the locking mechanism 38 in the forward unlocked configuration upon detection of the occurrence of a first event by a first one of the at least two event detectors, and to activate the drive assembly 64 to drive the barrier arm assembly 12 between the obstructing configuration and the forward non-obstructing configuration, upon detection of the occurrence of a second event by a second one of the at least two event detectors. For example and without being limitative, in an embodiment, the locking mechanism 38 is configured in the unlocked configuration upon detection of a motion by the optical sensors 15, while the activation the drive assembly 64 to drive the barrier arm assembly 12 between the obstructing configuration and the forward non-obstructing configuration may be triggered by a pressure sensed on the barrier 13 of the barrier arm assembly 12.

In an embodiment, reverse event detectors are provided to detect the occurrence of a reverse opening event. The reverse opening event may be an emergency event, such as, for example and without being limitative, a fire alarm. In an embodiment the reverse detectors may comprise an emergency push bar 23 configured to detect a constant pressure of a user thereon (in a reverse direction opposite arrow 19) for a predetermined time period, in order to trigger the reverse opening event. In an alternative embodiment, the reverse detectors may also comprise motion sensors configured to detect a motion of a person or an object in a reverse direction. For example and without being limitative, posts may be provided opposite to the entry posts 16 and 16a to form a reverse passageway obstructed by the barrier 13 of the barrier arm assembly 12 in the obstructing configuration 21. In the occurrence of a reverse opening event, the reverse arresting latch 53 of the reverse rotation solenoid 50 is unlocked by being configured in the disengaged configuration.

In an embodiment, the reverse event detector can comprise at least two event detectors, to detect a combination of events to configure the locking mechanism 38 in the reverse unlocked configuration upon detection of the occurrence of a first event by a first one of the at least two event detectors, and to activate the drive assembly 64 to drive the barrier arm assembly 12 between the obstructing configuration and the reverse non-obstructing configuration, upon detection of the occurrence of a second event by a second one of the at least two event detectors, similarly to the above described combination of forward event detectors.

In an embodiment, an opening event, either forward or rearward, can be the opening of an upstream barrier arm assembly. For instance, upon detection of the opening of an upstream barrier arm assembly, one of the arresting latches can be configured in a disengaged configuration and/or the drive assembly 64 can be actuated in rotation.

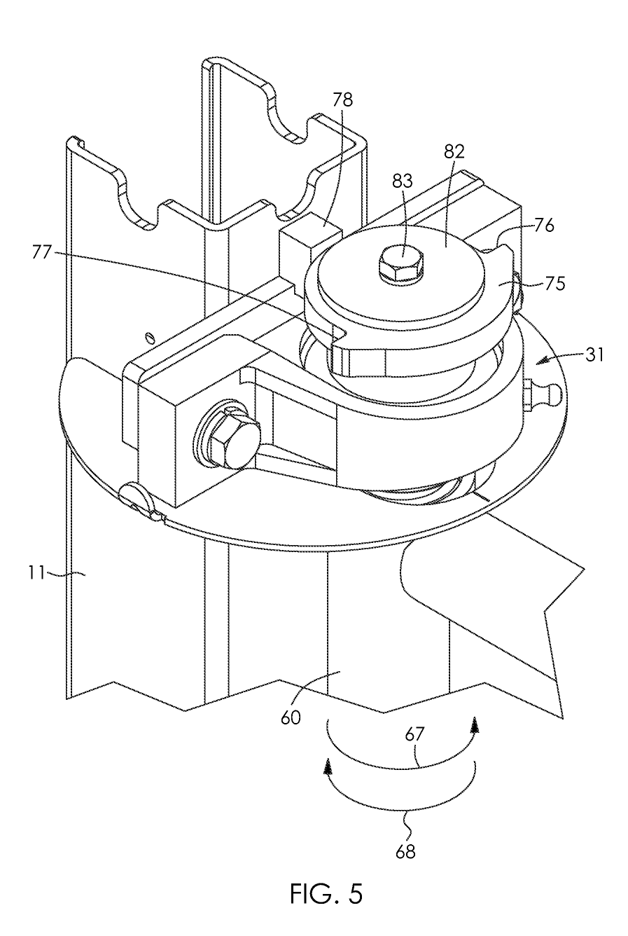

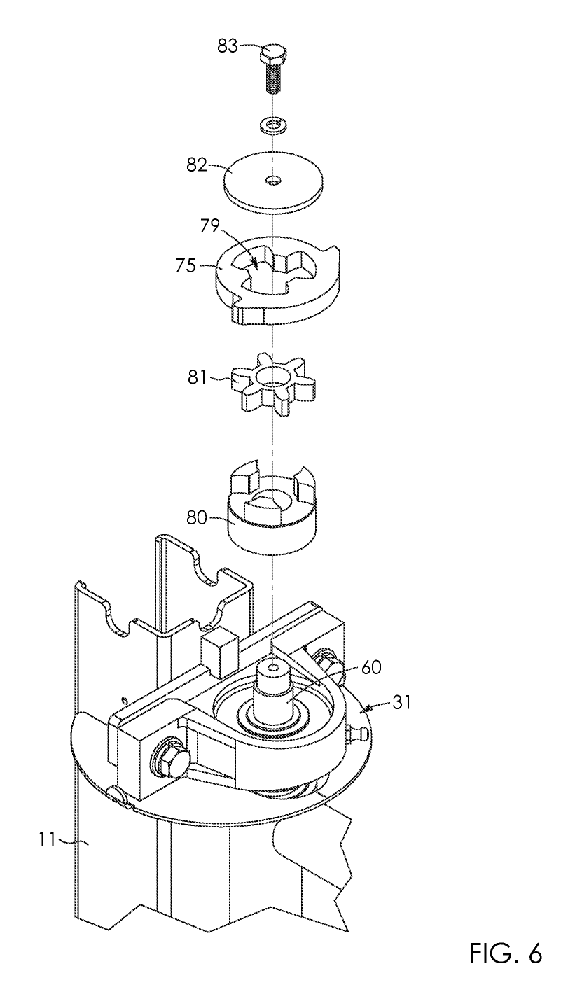

Now referring to FIGS. 5 and 6, the barrier arm assembly 12 further includes a course stopper 75 secured to the tubular support member 60 at an upper end thereof. In the embodiment shown, the course stopper 75 is in the shape of a ring surrounding the tubular support member 60. The course stopper 75 has a forward abutment surface 76 and a reverse abutment surface 77. The gate system 10 comprises an abutment member 78, which, in the embodiment shown, is mounted to the fixed support 11, above the upper bracket 31. The forward abutment surface 76 and the reverse abutment surface 77 are respectively positioned on the course stopper 75 to contact a side of the abutment member 78 when the barrier arm assembly 12 reaches the forward non-obstructing configuration and the reverse non-obstructing configuration, respectively. In other words, in the embodiment shown, the forward abutment surface 76 of the course stopper 75 is configured to contact the abutment member 78 following a rotation of about 90° of the barrier arm assembly 12 in the forward angular direction, from the obstructing configuration and the reverse abutment surface 77 of the course stopper 75 is configured to contact the abutment member 78 following a rotation of about 90° of the barrier arm assembly 12 in the reverse angular direction 68, from the obstructing configuration.

In an embodiment, the course stopper 75 comprises a damper assembly housed in a damper cavity 79 defined therein. The damper cavity 79 is shaped and sized to receive a combination of a coupler 80 and a rubber (resilient) spider 81, in order to dampen the movement of the barrier arm assembly 12 when either one of the forward non-obstructing configuration or the reverse non-obstructing configuration is reached. Indeed, in the embodiment shown, when the barrier arm assembly 12 has reached one of the forward non-obstructing configuration or the reverse non-obstructing configuration, the corresponding one of the forward abutment surface 76 and the reverse abutment surface 77 of the course stopper 75 contacts the abutment member 78 and the rubber spider 81 is contracted between the peripheral surface of the damper cavity 79 of course stopper 75 and the coupler 80 to provide the dampening effect. As can be seen, in the embodiment shown, the course stopper 75, the coupler 80 and the rubber spider 81 are positioned between a cover 82 mounted to the upper end of the tubular support member 60 by a screw 83 and an upper surface of the upper bracket 31.

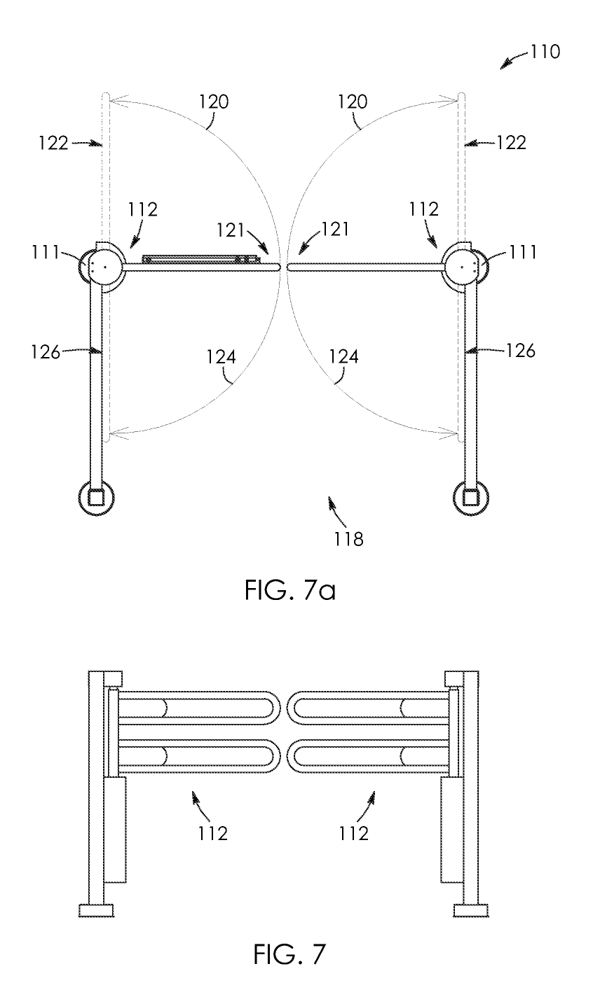

As shown in FIGS. 1, 1a, 7, and 7a, one skilled in the art will understand that, when installed in a store or other establishment, the lower bracket 30, locking mechanism 38, and drive assembly 64 are covered by a cover in order to prevent users from tempering with the gate system 10. Similarly, a cover may also be provided to cover the upper bracket 31.

In an embodiment, the gate system 10 further comprises a controller 36 to synchronize and control the barrier arm assembly 12, the locking assembly 37, the drive assembly 64, the event detector(s) such as the sensors 15, and the angular position sensor 70. In an embodiment, the controller 36 is embedded in the electronic card operatively connected to the magnetic position sensor 71. The barrier arm assembly 12, the locking assembly 37, the drive assembly 64, the event detector(s) such as the sensors 15, and the angular position sensor 70 are operatively connected to one another through the controller 36. For instance, the angular position sensor 70 and the event detector(s) provide information to the controller 36. Based on the information received from the angular position sensor 70 and the event detector(s), the controller 36 transmits instructions to the locking assembly 37 and the drive assembly 64. For instance, the controller 36 sends actuation instructions (or signals) to the forward rotation solenoid 40 and the reverse rotation solenoid 50 of the locking mechanism 38 and the drive assembly 64 in response to detection signals of the forward opening event and the reverse opening event received from the event detector(s). By being operatively connected to the at least one event detector, the locking mechanism 38, and the drive assembly 64, the controller 36 is configured to actuate the forward rotation solenoid 40 and the reverse rotation solenoid 50 to switch between engaged and disengaged configurations of the locking mechanism 38 and to operate the drive assembly 64 to rotate the tubular support member 60 of the barrier arm assembly 12 in either one of the forward angular direction 67 or the reverse angular direction 68. In an embodiment, the controller 36 is further connected to the angular position sensor 70 and operates the drive assembly 64 based on the angular position of the barrier arm detected by the angular position sensor 70.

In an embodiment, a key switch connection (not shown) may be provided for deactivating the locking mechanism 38 of the gate system 10 and allowing free pivoting of the barrier arm assembly 12. Moreover, in an embodiment audible and/or visual alarms may further be provided to produce an alarm when a time limit for the passage of a user in the passageway 18 is exceeded. A system for producing such alarms is described in the Applicant's U.S. Pat. No. 8,112,938 which is hereby included by reference in its entirety.

Now referring to FIGS. 7 and 7a, an alternative embodiment of the gate system 10 is shown with numeral reference in the 100 series. In the embodiment shown, the gate system 110 is a double-gates system where two barrier arm assemblies 112 are substantially aligned at the end of the passageway 118. Each one of the barrier arm assemblies 112 is pivotable between the obstructive configuration 121, the forward non-obstructive configuration 122, and the reverse non-obstructive configuration 126. Each one of the barrier arm assemblies 112 is driven by a drive assembly (not shown) between the above described configurations. One skilled in the art will understand that the construction and operation of each one of the barrier arm assemblies 112 of the gate system 110 is similar to that of the above described single gate system 10 and need not be repeated herein. In an embodiment, the gate system is controlled by a central controller (not shown), but one skilled in the art will understand that, in an alternative embodiment, other means or methods, such as without being limitative, a master controller and a slave controller may be used for controlling the operation of the gate system 110. One skilled in the art will understand that, in other alternative embodiments, more than two barrier arm assemblies 112 may be provided.

The components of the gate system 10 having now been described, the operation of the gate system 10 will now be described in more details. In operation, the gate system 10 is configured for the locking mechanism 38 to be configured in the locked configuration (shown in FIG. 3) until the occurrence of an opening event is detected.

The opening event can be a forward opening event, such as, for example and without being limitative, the motion of a person or an object entering into the passageway 18, the opening of an upstream barrier arm assembly or the like, detected by the motion sensor 15 of the event detector. As mentioned above, the forward opening event can be a combination of two events detected by different event detectors. Upon detection of the occurrence of the forward opening event, the gate systems 10 momentarily configures the barrier arm assembly 12 in the forward non-obstructive configuration 22, to allow passage of a user in the forward direction 19. The momentary configuration of the barrier arm assembly 12 in the forward non-obstructive configuration 22 is initiated by disengaging the forward rotation solenoid 40 to configure the locking mechanism in the forward unlocked configuration (shown in FIG. 3a). Subsequently, the drive assembly 64 is activated to pivot the tubular support member 60 in the forward angular direction until the barrier arm assembly 12 reaches the forward non-obstructing configuration 22. In an embodiment, the barrier arm assembly 12 is maintained in the forward non-obstructing configuration 22 for a time period, and the drive assembly 64 is subsequently re-activated to pivot the tubular support member 60 in the reverse angular direction until the barrier arm assembly 12 reaches the obstructing configuration 21. Once the obstructing configuration is reached, the forward rotation solenoid 40 is engaged to configure the locking mechanism in the locked configuration (shown in FIG. 3).

As mentioned above, in an embodiment the steps of disengaging the forward rotation solenoid 40 to configure the locking mechanism 38 in the forward unlocked configuration and subsequently activating the drive assembly 64 may be triggered by the detection of distinct forward opening events by distinct forward event detectors, i.e. a first event detected by a first detector triggers the configuration of the locking mechanism 38 in the forward unlocked configuration and a second event detected by a second detector triggers the activation of the drive assembly 64.

If an additional occurrence of the forward opening event is detected before the barrier arm assembly 12 is returned to the obstructing configuration 21, the previous step of activating the drive assembly 64 to pivot the tubular support member 60 in the forward angular direction until the barrier arm assembly 12 reaches the forward non-obstructing configuration 22, maintaining the barrier arm assembly 12 in the forward non-obstructing configuration 22 for a time period, and subsequently re-activating the drive assembly 64 to pivot the tubular support member 60 in the reverse angular direction until the barrier arm assembly 12 reaches the obstructing configuration 21, are performed once again.

It will be understood that in such a case, the angular position of the tubular support member 60 when the occurrence of the additional forward opening event is detected, as determined by the angular position sensor 70, is used to determine the required angular rotation of the tubular support member 60 by the drive assembly 64 to reach the forward non-obstructing configuration 22.

One skilled in the art will understand that, in an embodiment, the drive assembly 64 may operate to rotate the tubular support member 60 in the reverse angular direction immediately when the barrier arm assembly 12 reaches the forward non-obstructing configuration 22, without maintaining the barrier arm assembly 12 in the forward non-obstructing configuration 22 for a time period.

One skilled in the art will understand that the engagement of the forward rotation solenoid 40 to configure the locking mechanism in the locked configuration (shown in FIG. 3) is performed only when the detection of forward opening events are sufficiently spaced apart to allow the complete opening of the barrier arm assembly 12 in the forward non-obstructing configuration and a return of the barrier arm assembly 12 into the original obstructing configuration.

In an embodiment, the gate system 10 may further include a disabled user mode. In such an embodiment, the gate system 10 includes an opening push button pushable by disabled users to trigger the opening of the gate system 10 in the forward opening direction. In the disabled user mode, the above described momentarily configuration of the barrier arm 12 in the forward non-obstructive configuration 22, to allow passage of a user in the forward direction 19, is performed upon detection of the push of the opening push button as well as the detection of the forward opening event as described above, such as the motion of the disabled person into the passageway 18.

One skilled in the art will understand that, during the sequence of operation following the detection of the occurrence of a forward opening event, the reverse rotation solenoid 50 remains in an engaged configuration, thereby preventing rotation in the reverse angular direction beyond the obstructing configuration, in order to allow passage of users in the passageway in the forward direction only.

The event can also be a reverse opening event, such as, for example and without being limitative, an emergency event such as the detection of a pressure on the emergency push bar 23 during a predetermined time period, a fire alarm, or the like. Upon detection of the occurrence of the emergency reverse opening event, the gate systems 10 configures the barrier arm assembly 12 in the reverse non-obstructive configuration 26, to allow passage of users in the reverse direction, opposite to the direction of arrow 19. The configuration of the barrier arm assembly 12 in the reverse non-obstructive configuration 26 is initiated by disengaging the forward rotation solenoid 40 and the reverse rotation solenoid 50 to configure the locking mechanism in the unlocked configuration (shown in FIG. 3c). Subsequently, the drive assembly 64 is activated to pivot the tubular support member 60 in the reverse angular direction until the barrier arm assembly 12 reaches the reverse non-obstructing configuration 26. In an embodiment, the barrier arm assembly 12 subsequently remains in the reverse non-obstructing configuration 26 until the gate system is reactivated manually. In an embodiment, the system is reactivated manually by a user by resetting the gate system 10 using a key system. Given that the locking mechanism is configured in the unlocked configuration (shown in FIG. 3c), users may manually pivot the barrier arm assembly 12 in any desired angular position best suited for exiting the store. In the event of a power loss, the barrier arm assembly 12 remains in the configuration in which it was when the power loss occurred, for example, the reverse non-obstructing configuration.

In an alternative embodiment, the reverse opening event may not be an emergency event, but can rather be indicative of a user exiting the store, for example by detecting an exiting movement with additional reverse sensors (not shown). In such an embodiment, the configuration of the barrier arm assembly 12 in the reverse non-obstructive configuration 26 may be initiated by disengaging the reverse rotation solenoid 50 to configure the locking mechanism in the reverse unlocked configuration (shown in FIG. 3b). Subsequently the drive assembly 64 is activated to pivot the tubular support member 60 in the reverse angular direction until the barrier arm assembly 12 reaches the reverse non-obstructing configuration 26. The barrier arm assembly 12 can then be maintained in the reverse non-obstructing configuration 26 for a time period, and the drive assembly 64 is subsequently re-activated to pivot the tubular support member 60 in the forward angular direction until the barrier arm assembly 12 reaches the obstructing configuration 21. Once the obstructing configuration is reached, the reverse rotation solenoid 50 is engaged to configure the locking mechanism in the locked configuration (shown in FIG. 3). Once again, if an additional detection of the occurrence of the reverse opening event occurs before the barrier arm assembly 12 is returned to the obstructing configuration 21, the steps of activating the drive assembly 64 to pivot the tubular support member 60 in the reverse angular direction until the barrier arm assembly 12 reaches the reverse non-obstructing configuration 26, maintaining the barrier arm assembly 12 in the reverse non-obstructing configuration 26 for a time period, and subsequently re-activating the drive assembly 64 to pivot the tubular support member 60 in the forward angular direction until the barrier arm assembly 12 reaches the obstructing configuration 21 may be performed.

One skilled in the art will understand that, in an embodiment, the drive assembly 64 can operate to rotate the tubular support member 60 in the forward angular direction immediately when the barrier arm assembly 12 reaches the reverse non-obstructing configuration 26, without maintaining the barrier arm assembly 12 in the reverse non-obstructing configuration 26 for a time period.

In an embodiment the steps of disengaging the reverse rotation solenoid 50 to configure the locking mechanism 38 in the reverse unlocked configuration and subsequently activating the drive assembly 64 may be triggered by the detection of distinct reverse opening events by distinct reverse event detectors, i.e. a first event detected by a first detector triggers the configuration of the locking mechanism in the reverse unlocked configuration and a second event detected by a second detector triggers the activation of the drive assembly 64.

In an embodiment, additional theft protection may be used. For example a theft detector (not shown) which detects active security protective devices placed on articles to prevent theft may also be provided. In the event that a user passes through the detector detecting exit motion, with the security device disarmed, then the normal reverse opening of the barrier arm assembly 12 is carried to allow the user to freely exit the store. In the event that the theft detector detects an active security device, the locking mechanism 38 can, for example, remain in the locked configuration to prevent reverse opening of the barrier arm assembly 12.

Several alternative embodiments and examples have been described and illustrated herein. The embodiments of the invention described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while specific embodiments have been illustrated and described, numerous modifications come to mind without significantly departing from the scope of the invention as defined in the appended claims.

1. A motorized gate system comprising:
a fixed support;
a barrier arm assembly pivotally mounted to the fixed support and being pivotable between an obstructing configuration, a forward non-obstructing configuration, and a reverse non-obstructing configuration;
at least one event detector configured to detect an occurrence of at least one forward opening event and at least one reverse opening event; and
a drive assembly operatively connected to the barrier arm assembly to rotate same clockwise and counterclockwise between the obstructing configuration, the forward non-obstructing configuration, and the reverse non-obstructing configuration.

2. The gate system of claim 1, further comprising a locking mechanism configurable in a locked configuration locking the barrier arm assembly in the obstructing configuration, a forward unlocked configuration allowing pivoting of the barrier arm assembly between the obstructing configuration and the forward non-obstructing configuration, and at least one of a reverse unlocked configuration and an unlocked configuration allowing pivoting of the barrier arm assembly between the obstructing configuration and the reverse non-obstructing configuration.

3. The gate system of claim 2, further comprising a controller operatively connected to the at least one event detector, the locking mechanism, and the drive assembly, the controller being configured to configure the locking mechanism in the forward unlocked configuration and activate the drive assembly to drive the barrier arm assembly between the obstructing configuration and the forward non-obstructing configuration, upon detection of the occurrence of the forward opening event by the at least one event detector.

4. The gate system of claim 3, wherein the at least one event detector comprises at least two event detectors and wherein the controller is configured to configure the locking mechanism in the forward unlocked configuration upon detection of the occurrence of a first forward opening event by a first one of the at least two event detectors, and to activate the drive assembly to drive the barrier arm assembly between the obstructing configuration and the forward non-obstructing configuration, upon detection of a second forward opening event by a second one of the at least two event detectors.

5. The gate system of claim 4, wherein the controller is configured to configure the locking mechanism in one of the reverse unlocked configuration and the unlocked configuration and to activate the drive assembly to drive the barrier arm assembly between the obstructing configuration and the reverse non-obstructing configuration, upon detection of the occurrence of the reverse opening event by the at least one event detector.

6. The gate system of claim 5, wherein the at least one event detector comprises at least two event detectors and wherein the controller is configured to configure the locking mechanism in one of the reverse unlocked configuration and the unlocked configuration upon detection of the occurrence of a first reverse opening event by a first one of the at least two event detectors, and to activate the drive assembly to drive the barrier arm assembly between the obstructing configuration and the reverse non-obstructing configuration, upon detection of the occurrence of a second reverse opening event by a second one of the at least two event detectors.

7. The gate system of claim 2, wherein the barrier arm assembly comprises a locking stopper with a forward abutment surface and a reverse abutment surface and wherein the locking mechanism comprises a forward rotation solenoid with a forward arresting latch selectively engageable with the forward abutment surface in the locked and reversed unlocked configurations and a reverse rotation solenoid with a reverse arresting latch selectively engageable with the reverse abutment surface in the locked and forward unlocked configurations.

8. The gate system of claim 1, wherein the fixed support comprises a fixed abutment member and wherein the barrier arm assembly comprises a course stopper having a forward abutment surface and a reverse abutment surface respectively positioned to contact a side of the fixed abutment member when the barrier arm assembly reaches a respective one of the forward non-obstructing configuration and the reverse non-obstructing configuration.

9. The gate system of claim 8, wherein the course stopper comprises a dampening cavity, a coupler and a resilient spider, the coupler and the resilient spider being inserted in the dampening cavity with the resilient spider being compressible to dampen a movement of the barrier arm assembly when one of the forward non-obstructing configuration or the reverse non-obstructing configuration is reached.

10. The gate system claim 1, wherein the barrier arm assembly comprises a rotatable member and wherein the drive assembly comprises a drive shaft and a coupling, the drive shaft being substantially aligned with the rotatable member and engaged therewith through the coupling.

11. The gate system of claim 10, wherein the drive assembly comprises a stepper motor.

12. The gate system of claim 10, further comprising an angular position sensor configured to detect an angular position of the barrier arm assembly, the angular position sensor comprising a magnetic position sensor, a permanent magnet and an electronic card, the magnetic position sensor being connected to the electronic card and sensing an orientation of the permanent magnet, the permanent magnet rotating synchronously with at least one of the drive shaft of the drive assembly and the barrier arm assembly, the orientation of the permanent magnet being modified when rotated.

13. A method for controlling a motorized gate system having a barrier arm assembly pivotable between an obstructing configuration, a forward non-obstructing configuration and a reverse non-obstructing configuration, a drive assembly operatively connected to the barrier arm assembly and a locking mechanism operatively connected to the barrier arm assembly, the method comprising the steps of:
monitoring an occurrence of a forward opening event and a reverse opening event by at least one event detector;
upon detection of the occurrence of the forward opening event:
driving the drive assembly in a forward angular direction to pivot the barrier arm assembly towards the forward non-obstructing configuration; and
driving the drive assembly in a reverse angular direction to return the barrier arm assembly to the obstructing configuration; and
upon detection of an occurrence of the reverse opening event, driving the drive assembly in the reverse angular direction to pivot the barrier arm assembly towards the reverse non-obstructing configuration.

14. The method of claim 13, further comprising the step of configuring the locking mechanism in a forward unlocked configuration upon detection of the occurrence of the forward opening event.

15. The method of claim 14, wherein the detection of the occurrence of the forward opening event comprises the detection of a first forward opening event and a second forward opening event, the detection of the first forward opening event triggering the step of configuring the locking mechanism in the forward unlocked configuration and the detection of the second forward opening event triggering the step of driving the drive assembly.

16. The method of claim 13, further comprising the step of maintaining the barrier arm assembly in the forward non-obstructing configuration for a time period.

17. The method of claim 13, further comprising the step of configuring the locking mechanism in the locked configuration to lock the barrier arm assembly in the obstructing configuration, once the barrier arm assembly has returned to the obstructing configuration from the forward non-obstructing configuration.

18. The method of claim 13, further comprising the step of configuring the locking mechanism in one of a reverse unlocked configuration and an unlocked configuration to allow pivoting of the barrier arm assembly at least towards the reverse non-obstructing configuration, upon detection of an occurrence of the reverse opening event.

19. The method of claim 13, wherein upon detection of an occurrence of the reverse opening event, the method further comprises:
maintaining the barrier arm assembly in the reverse non-obstructing configuration for a time period;
driving the drive assembly operatively connected to the barrier arm assembly in the forward angular direction to return the barrier arm assembly to the obstructing configuration; and
configuring the locking mechanism in the locked configuration to lock the barrier arm assembly in the obstructing configuration.

20. The method of claim 18, further comprising the step of detecting an angular position of the barrier arm assembly and wherein the steps of configuring the locking mechanism in the locked configuration is performed if the detected angular position is the angular position corresponding to the obstructing configuration.

21. The method of claim 13, wherein the barrier arm assembly comprises a rotatable member and the drive assembly comprises a drive shaft aligned and directly connected to the rotatable member and wherein the step of driving the drive assembly operatively connected to the barrier arm assembly comprises the step of rotating the drive shaft of the drive assembly to engage the rotatable member in rotation.

22. A gate system comprising:
a fixed support;
a barrier arm assembly pivotally mounted to the fixed support and being pivotable between an obstructing configuration, a forward non-obstructing configuration, and a reverse non-obstructing configuration, the barrier arm assembly having a locking stopper with a forward abutment surface and a reverse abutment surface;
a forward rotation solenoid with a forward arresting latch selectively engageable with the forward abutment surface of the locking stopper in a locked configuration and a reversed unlocked configuration; and
a reverse rotation solenoid with a reverse arresting latch selectively engageable with the reverse abutment surface in the locked configuration and a forward unlocked configuration.

23. The gate system of claim 22, further comprising at least one event detector configured to detect an occurrence of at least a forward opening event and a reverse opening event.

24. The gate system of claim 22, further comprising a drive assembly operatively connected to the barrier arm assembly to rotate same clockwise and counterclockwise between the obstructing configuration, the forward non-obstructing configuration, and the reverse non-obstructing configuration.

25. The gate system of claim 22, wherein the fixed support comprises a fixed abutment member and wherein the barrier arm assembly comprises a course stopper having a forward abutment surface and a reverse abutment surface respectively positioned to contact a side of the fixed abutment member when the barrier arm assembly reaches a respective one of the forward non-obstructing configuration and the reverse non-obstructing configuration.

26. The gate system of claim 25, wherein the course stopper comprises a dampening cavity, a coupler and a resilient spider, the coupler and the resilient spider being inserted in the dampening cavity with the resilient spider being compressible to dampen a movement of the barrier arm assembly when one of the forward non-obstructing configuration or the reverse non-obstructing configuration is reached.

27. The gate system of claim 24, wherein the barrier arm assembly comprises a rotatable member and wherein the drive assembly comprises a drive shaft and a coupling, the drive shaft being substantially aligned with the rotatable member and engaged therewith through the coupling.

28. The gate system of claim 27, wherein the drive assembly comprises a stepper motor.

29. The gate system of claim 27, further comprising an angular position sensor configured to detect an angular position of the barrier arm assembly, the angular position sensor comprising a magnetic position sensor, a permanent magnet and an electronic card, the magnetic position sensor being connected to the electronic card and sensing an orientation of the permanent magnet, the permanent magnet rotating synchronously with at least one of the drive shaft of the drive assembly and the barrier arm assembly, the orientation of the permanent magnet being modified when rotated.
